(19) United States
(12) Patent Application Publication
(10) Pub. No.: US 2024/0013284 A1
(43) Pub. Date: Jan. 11, 2024

(54) APPARATUS AND METHOD FOR FACILITATING A SHOPPING EXPERIENCE

(71) Applicant: GHOST RETAIL INC., Barrie (CA)

(72) Inventors: TYLER MURRAY, Barrie (CA); JIMMY FURLANO, Toronto (CA)

(21) Appl. No.: 17/427,048

(22) PCT Filed: Jul. 23, 2021
(86) PCT No.: PCT/CA2021/051036

§ 371 Date: Jan. 26, 2023

(51) Int. Cl. G06Q 30/0601

(52) U.S. Cl. CPC G06Q 30/0635; G06Q 30/0631

(57) ABSTRACT

A machine-implemented method for facilitating a shopping experience for a customer with a customer device and a sales associate with a sales associate device, includes handling a call request, generating a set of products, causing the set of products to be displayed on the customer device, initiating an AV call between the customer device and the sales associate device, populating a cart, and concluding a transaction via a sales associate-initiated check out instruction. Data from the customer device and the sales associate may be collected.

### TECHNICAL FIELD

The present invention relates to the sale of goods or services in general, and to online communication for the sale of goods or services in particular.

### BACKGROUND

A merchant may sell goods and/or services (which may be referred to collectively and individually as product or products) directly to a customer at a brick-and-mortar store or physical location (which may be referred to as a physical store). The customer can browse products for sale in person, including inspecting the products, and possibly testing the products. Merchants may curate physical displays of products. Such curated displays may make such products more appealing to the customer, and/or may serve to educate the customer about such products.

One advantage of a physical store is that a sales associate of the merchant may attend to the customer to assist them in selecting a particular product for purchase. The sales associate may market and/or promote certain products to the customer, for reasons that may or may not align with the customer's motives, and may or may not be apparent to the customer. For example, the merchant may desire to sell overstocked products or upsell and/or cross-sell features or additional product or products with greater profit margins.

Physical stores have many disadvantages. The size of the physical store may be limited by real estate costs and availability. For the customer, it may be inconvenient or impossible to visit the physical store, for example due to proximity or time constraints. For the merchant in the context of a physical store, it may be difficult to collect and use data about the customer to inform how the merchant markets its products to the given customer. Furthermore, social or legal restrictions on movement and assembly (including without limitation restrictions associated with the COVID-19 pandemic) may prevent the merchant and/or customer from accessing the physical store. Physical stores are limited by their physical size in regard to the number of sales associates that can effectively be working in the store at any given time, lessening the number of customers that may be served.

Alternatively, the merchant may sell products through an online store. The online store may include a catalog of products from which a customer may select products and add them to a cart, and once all desired products are selected, the customer can complete their transaction, and the online store may initiate a process to deliver the purchased products to the customer. One advantage of an online store is that the merchant can collect and use data about the customer to promote certain products to the customer. Online stores have many disadvantages. One disadvantage is the inability to capture the customer's verbal and non-verbal cues to inform the merchant's marketing efforts. Another disadvantage is the technological know-how required to use an online store. For example, customers with disabilities, elderly customers, and/or others may find online stores difficult or impossible to use, either in and of themselves or in comparison to physical stores. Similarly, as an example, the capability of sales people to interact with online customers in a rich and tailored environment is not readily accessible or available to the sales associate. There is a demand for a shopping experience that mitigates one or more of the aforementioned problems of online stores and physical stores.

### SUMMARY OF INVENTION

In accordance with a broad aspect of the present invention, there is provided a machine-implemented method for facilitating a shopping experience for a customer with a customer device and a sales associate with a sales associate device, comprising: handling a call request, including receiving, by a processor of a server, the call request from the customer via the customer device, and adding, by the processor, a customer identifier associated with the customer to a customer queue of the database, generating, by the processor, a set of products; causing the set of products to be displayed on the customer device; coupling the customer device and the sales associate device, including displaying, on the sales associate device, the customer queue retrieved by the processor from a database of the server; receiving, by the processor, a join call request from the sales associate device; and initiating an AV call, including causing the sales associate device to record and send a first AV stream to the customer device for display thereon; populating a cart with at least one product; concluding a transaction, including receiving, from the sales associate device, a check out instruction, and triggering an order fulfillment process; and ending the AV call, including receiving, from one of the sales associate device and the customer device, an end call request; and collecting a first set of customer data from the customer via the customer device and collecting a second set of customer data about the customer via the sales associate device and storing the first set of customer data and the second set of customer data to the server.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

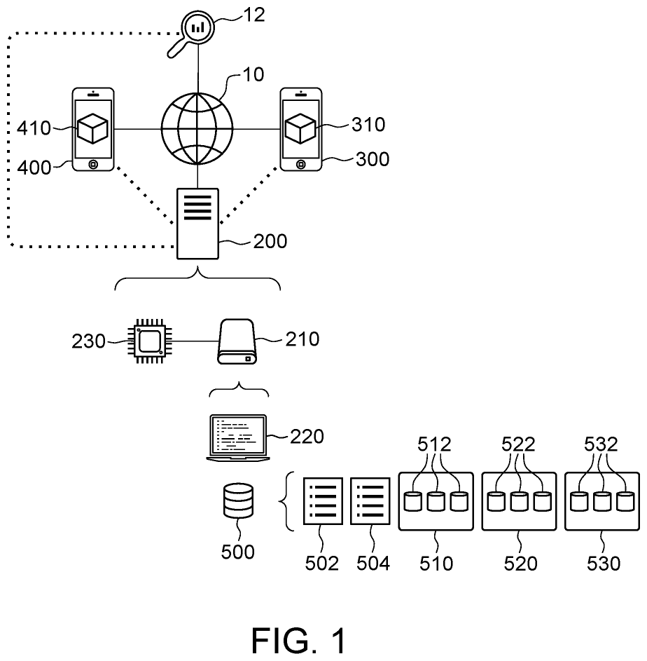

(a) FIG. 1 is a block diagram illustrating an example system architecture according to one embodiment of the present invention;

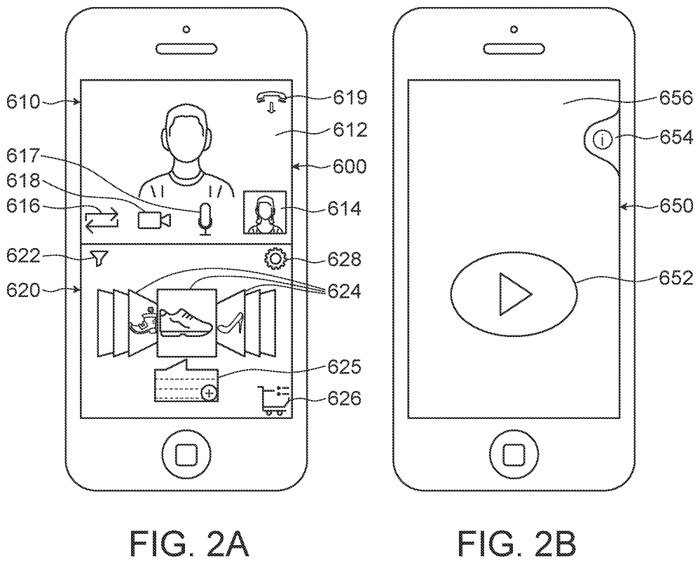

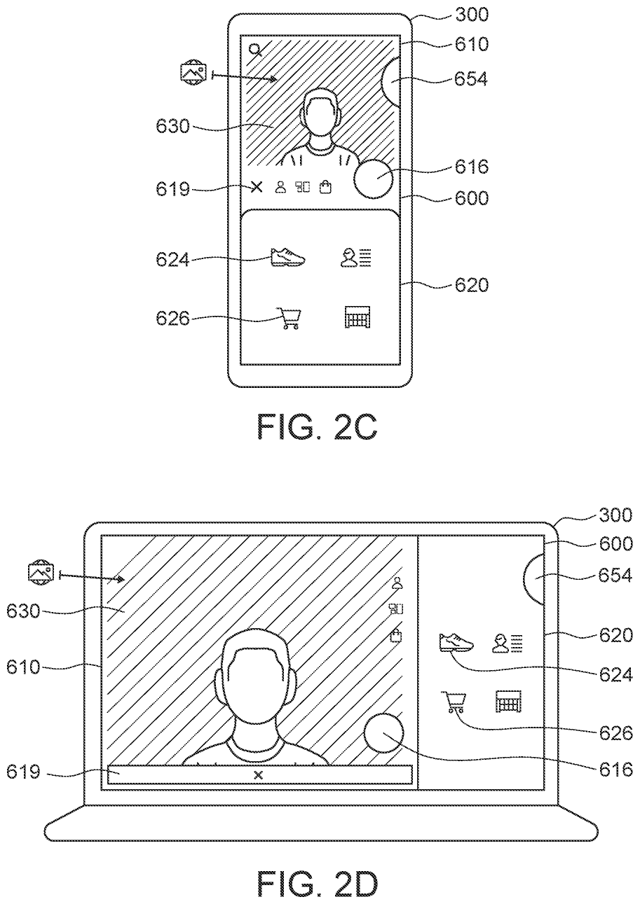

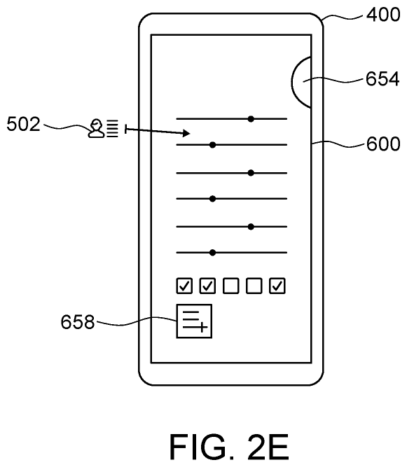

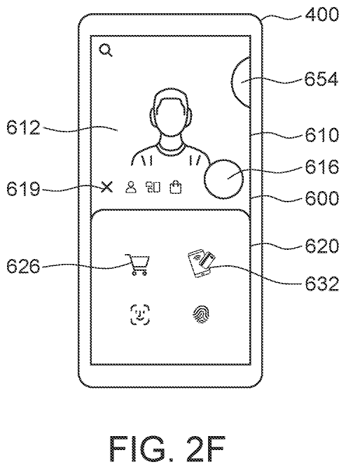

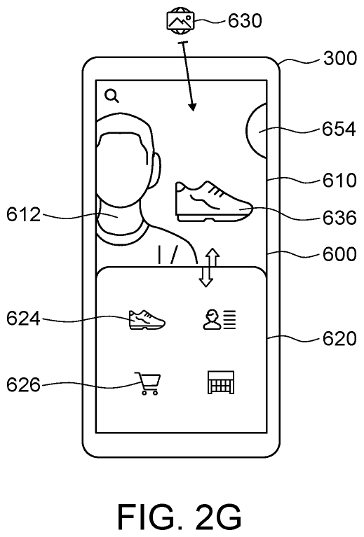

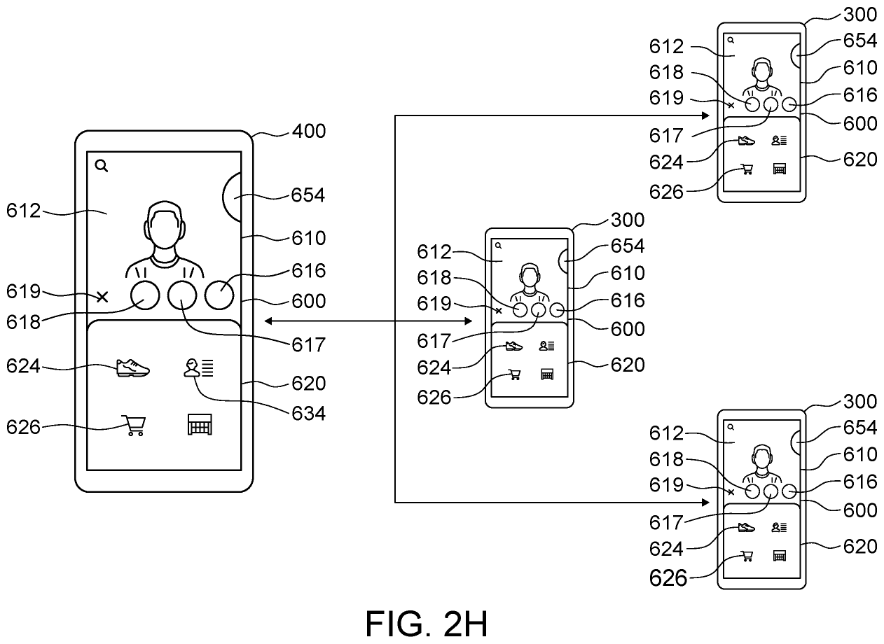

(b) FIG. 2A is a diagram illustrating an example graphical user interface that is generated according to one embodiment of the present invention;

(c) FIG. 2B is a diagram illustrating an example graphical user interface that is generated according to one embodiment of the present invention;

(d) FIG. 2C is a diagram illustrating an example graphical user interface that is generated according to one embodiment of the present invention wherein the user's background is augmented by use of computer-generated reality;

(e) FIG. 2D is a diagram illustrating an example graphical user interface, presented on a laptop user device, that is generated according to one embodiment of the present invention wherein the user's background is augmented by use of computer-generated reality;

(f) FIG. 2E is a diagram illustrating an example graphical user interface showing a customer queue that is generated according to one embodiment of the present invention;

(g) FIG. 2F is a diagram illustrating an example graphical user interface, showing a checkout button on a sales associate device, that is generated according to one embodiment of the present invention;

(h) FIG. 2G is a diagram illustrating an example graphical user interface, showing a checkout button on a sales associate device, that is generated according to one embodiment of the present invention wherein the user's video stream is augmented by use of computer-generated reality of a product;

(i) FIG. 2H is a diagram illustrating an example group call with multiple customer devices connected to the same sales associate device; and

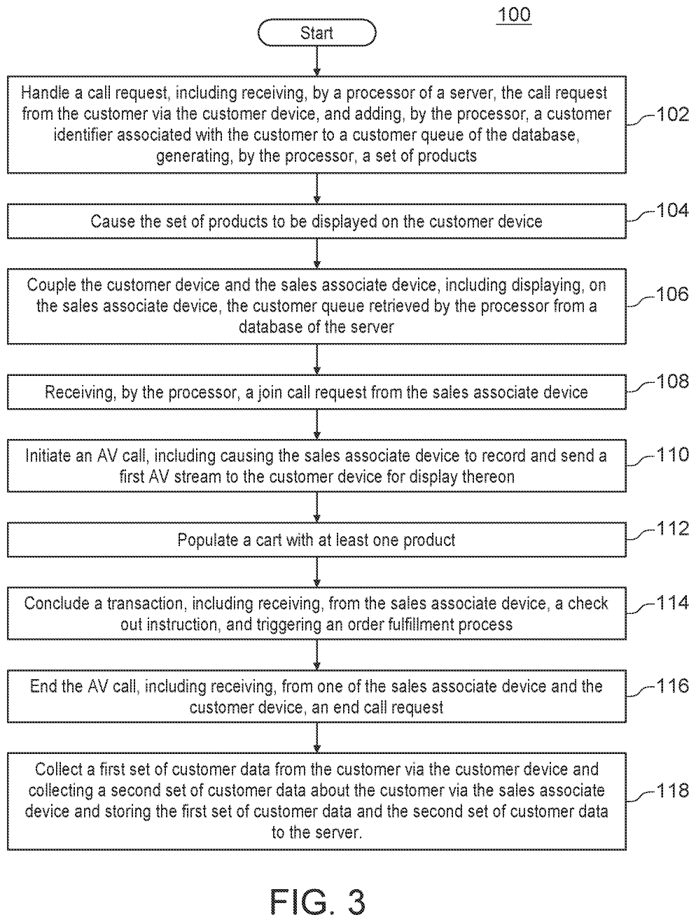

(j) FIG. 3 are sequence diagrams illustrating a sequence of operations that may be performed by elements of FIG. 1, according to one embodiment of the present invention.

### DETAILED DESCRIPTION OF EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

### General Overview

In one embodiment, the present invention may include a method to facilitate a shopping experience. The method may be computer-implemented. The shopping experience may include a video call between a customer (or multiple customers) and a sales associate (or multiple sales associates). To initiate a video call, the customer may open an application on a user device and indicate that they are ready to shop. The user device may be, for example, a smartphone, a tablet, a laptop, or a desktop computer. Indicating that the user is ready to shop on the user device may be referred to as a call request. The customer may then be added to a customer queue, or be instantly connected to a sales associate. While in the queue, the customer may browse products, be shown advertisements, or simply wait for the sales associate to join the call. The sales associate may receive a notification that a customer is waiting in the queue. The sales associate can then join the video call with the customer, such that they will be able to see and hear each other through real-time audio and video (AV) streams. Once the sales associate joins the call, the customer is removed from the customer queue. The video stream may be augmented by use of a computer-generated reality, which may be referred to as augmented or virtual reality. The AV stream may alternatively be a limited transmission without full duplex audio and video, for example, audio only, or text, or non-streaming visual components, which may be useful where circumstances such as equipment or network capability or the like are constraining.

Prior to joining the call and/or during the call, the sales associate may be able to see information about the customer that is or has been collected automatically, such as products they have purchased in the past, products they have returned, how long they were waiting for the associate to join the call, their average spend (for example, how much money they spend, on average, per transaction), demographic and other similar information, and so on. In addition to the information that is collected automatically, the sales associate can ask the customer questions, for example about any products for which they are shopping. The sales associate can show products to the customer in one or more ways, including: using the camera of their device, and/or by selecting an item from the catalog in their device application to be presented to the customer's screen. The sales associate and/or the customer can add items to the customer's cart, and when all items have been added, the customer and/or sales associate can conclude the transaction, often by informal communication between them during the streaming conversation rather than through a standard shopping cart and click-to-purchase transaction by the customer, which charges the total price of all products to the customer's payment method and initiates a product shipment process. The customer and sales associate may then be disconnected, and prompted to answer questions (such as a rating of 0-5, or more detailed questions).

The sales associate may be in a physical store, and may wander around the store to show products to the customer. The store may be used as a physical store by the public and other employees of the merchant at the same time as the sales associate uses it in connection with the present method. Alternatively, the sales associate may be on a set that has been configured for the purpose of the present method. The customer may be at their own home, and may wander around their home to show the sales associate their closet, furniture, etc., to give the sales associate information about their tastes. It is to be understood that the customer's home is used as an example, and the customer could also be in their work place or on location and could similarly show the sales associate around the location and share images and/or video of industrial equipment or other materials. This reduces the need for sales associates to travel to the customer's location.

### Architecture

With reference to FIGS. 1, 2A and 2B, and in particular FIG. 1, in one embodiment, the present invention may include a method to facilitate a shopping experience. The method may be computer-implemented, including a server 200 in communication with a customer device 300 and a sales associate device 400. In one embodiment, server 200, customer device 300, and sales associate device 400 are all connected to the internet 10, and server 200 is in communication with each of customer device 300 and sales associate device 400 over the internet. Server 200 may include media 210 for storing data 500 and/or instructions 220. The method may include a customer application 310 for the customer device 300 to download, and a merchant application 410 for the sales associate device 400 to download.

Customer device 300 and sales associate device 400 may transmit data directly to and from each other, or, alternatively, may transmit data to and from each other via server 200. Server 200 may act as a communications bridge to connect the customer device 300 and the sales associate device 400. Regardless of how the customer device 300 and sales associate device 400 communicate with each other, the respective devices may be able to transmit and receive AV stream data in real time. The term “real time” here refers to the transmission of data (for example, a live or augmented AV stream) from a first device to a second device (and possibly vice versa) with low latency (e.g., less than three seconds from the time AV is recorded on the first device to the time it is played on the second device, and optionally less than one half of one second). Server 200 may be cloud-based. One or more of customer device 300, sales associate device 400, and server 200 may run the same or different software to establish a communication link between two of them (or possibly up to and including all of them).

Server 200 may receive data (including AV stream data) from a first device (such as customer device 300) and a processor 230 of the server may process such data to render such data compatible with a second device (such as sales associate device 400) such that the data from the first device may be transmitted to and viewed on the second device. The server can also receive data from the second device, and process it to be compatible for the second device to be transmitted to and viewed on the second device. The processor may process data sent or received by the server, including, for example, data received by the server from the customer device, sales associate device, a tracking service, or a combination thereof. Processing may include transcoding audio and/or video data from one format to another, and/or compressing data. Processing may include modifying one or more of the AV streams or other types of images and media, for example by one or more of: enhancing colours and other visual or audio aspects of the AV stream, replacing backgrounds using chroma key compositing, modifying the image using augmented reality human occlusion, or other forms of augmented reality, modifying the image based on time of day, modifying the image based on customer parameters (such as settings, gender, age, skin tone, style of clothing worn, colour of clothing worn, height, body shape, weight, other data collected about the customer, etc.). Chroma key compositing is a visual effects and post-production technique for compositing or layering two images or video streams together based on colour hues (chroma range) commonly known as “green screen” technology. Other forms of compositing may be used in addition to or instead of chroma key compositing. The AV stream may be further modified by incorporating advertisements therein. Such advertisements may be selected or created based on data collected about the customer. With reference to FIGS. 2C and 2D, the user's background 630 may be modified using chroma key compositing.

Server 200 may include one or more relational databases to store and relate data 500, including a customer queue 502, a sales associate queue 504, a product data set 510, a customer data set 520, and a sales associate data set 530. Such data 500 may be stored on media 210 and accessed and/or recorded by processor 230. The product data set 510 may include a table of products 512 of the merchant, and information associated with such products 512. For example, the product data set may include a table of products (e.g., as rows of the table of products), and each product 512 may be associated with, for example, one or more of (e.g., each as one or more columns of the table of products) a price, a brand, a number of units available, a number of units sold, a date of first release, and any other custom fields selected for the given products and variants. For example, if the product is clothing, the product variants may be associated with options for sizes, patterns, colours, fit, and style.

The customer data set 520 may include a table of customers 522, and information associated with such customers 522. Each customer 522 may be associated with data collected directly or indirectly from the customer. For example, one or more of the customers 522 (as rows of the table of customers) may be associated with (as columns of the table of customers) past purchases of any number of products 512 of the product data set 510. Each customer 522 may be associated with customer relationship management data obtained from the internet (for example, from a tracking service 12 that tracks how users behave online, including their search and purchase history from various websites), and/or data collected directly from the customer, such as one or more of their name, username, password, email address, age, height, weight, gender, shipping address, billing address, payment method (such as credit card number), contract or instructions authorizing sales associate to invoke or complete payment transactions on customer's behalf, and/or data associated with their interactions with the present method, such as products they have browsed and/or in which they expressed interest (or disinterest), products they have rated, reviewed, and/or returned, and representations they have made regarding, for example, budget, sizes, tastes, colours, patterns, etc.

The sales associate data set 530 may include a table of sales associates 532 of the merchant. Each sales associate 532 may be associated with data about their sales history, for example, data regarding one or more of: customers 522 with whom the given associate has interacted, products 512 the sales associate has sold, average daily sales volume, average call time, number of calls to date, conversion rate of calls to sales, and average number of items sold per sale. Other data associated with the sales associate may include one or more of the sales associate's name, username, password, email address, age, height, weight, gender or any other information that may be selected to be stored in the sales associate's profile.

Each of customer device 300 and sales associate device 400 may be internet protocol (IP) based devices able to capture and record audio and video and transmit data (including such audio and video) from the device to another IP-based device or server accessible via the internet. Examples of such devices include camera phones, tablet computers, and cameras. Customer device 300 and/or sales associate device 400 may each be of any number of types of user devices, such as smart phones (for example various models and operating systems such as iPhone®, Samsung®, Google®, iOS®, Android®, Blackberry®, etc.), personal digital assistants (PDAs), smart speakers (for example Alexa®), desktop computers, laptop computers, etc. The customer device 300 and sales associate device 400 may be different or the same type of device. Each of customer device 300 and sales associate device 400 may include a screen, a user input means (such as one or more of a touch screen (which may be integral with the screen), a keypad, a keyboard, a mouse, a joystick, a voice processor, and/or a track pad) a processor (e.g., a processor 302 of the customer device and a processor 402 of the sales associate device), one or more cameras (e.g., a camera 304 of the customer device and a camera 404 of the sales associate device) (for example, a front-facing camera and/or a rear-facing camera) to record still photos and/or video; and one or more microphones to record audio.

### Graphical User Interface

FIGS. 2A-G depict examples of graphical user interface (GUI) 600 according to various embodiments. With reference to FIGS. 2A and 2B, Using the customer device as an example, GUI 600 may be generated and displayed on the screen of the customer device when executed by customer application 310 on the processor of the customer device. Alternatively, GUI 600 may be generated by execution of another software application, such as an internet browser. The GUI may be modified, for example, based on data collected about the customer. In one embodiment, aspects of the GUI, such as images, videos, typefaces, colours, layout, etc., may be selected according to data collected about the customer, such as the customer's age or clothing worn in their AV stream. Such aspects of the GUI may be selected by the server and displayed on the customer device.

GUI 600 may include an AV interface 610 and a product interface 620. For example, AV interface 610 may occupy an upper portion of GUI 600, and product interface 620 may occupy a lower portion of GUI 600. It is to be understood that the portions' positions could be reversed or changed such that the AV interface is below the product interface, or alternatively such that they are side-by-side or that they occupy multiple and possibly overlapping and/or intersecting areas of the screen.

AV interface 610 may include a first video window 612 (showing video received from another device) and a second video window 614 (showing the video that is being sent to another device from the instant device). One or both of the video windows may be resized, for example by dragging the corners or edges of the video windows. One or both of the video windows may be hidden, for example by accessing a settings menu 628 of the GUI.

GUI may further include one or more of: an end call button 619 to end the call; a mute audio toggle button 617 to mute and unmute audio being recorded and transmitted, a disable video toggle button 618 to mute and unmute audio being recorded and transmitted, a camera toggle button 616 to toggle between a front facing camera and a rear facing camera, and a settings menu 628 for accessing other menu options.

Product interface 620 may include one or more product buttons 624. Each product button may be associated with one of products 512. The user can interact with buttons 624 in any number of ways. For example, swiping from left to right on buttons 624 will move the buttons off the screen and (figuratively) pull different products onto the screen such that the user may view other products. The user can interact with buttons by, for example, tapping and/or clicking on one of them, which may allow the user to add the product associated with that particular button to a list or cart (which is a list of products that is populated during the shopping session). Alternatively, clicking, gesturing, tapping or tapping in a different manner (e.g., double-tapping or tap-and-hold) on the product may allow the user to view further information about the given product, for example in pop-up 625. GUI may include a filter button 622 which may filter the products according to various options (such as size, colour, brand, etc). GUI may include a cart button 626 to open a menu to view and/or remove items from the cart or to “check out” to conclude the transaction. In one embodiment, the sales associate can check out, without any further check out confirmation or check out action on the part of the customer, which simplifies the transaction process for the customer. This action may be triggered via a checkout button 632 in GUI 600. Any of the buttons (including toggles) may be shown with an identifier (such as an image or icon) in GUI 600. Depending on whether the user is a customer or a sales associate, i.e., whether the device is a sales associate device or a customer device, different menu items may be visible, and/or different menu items may trigger different functions.

In one embodiment, the shopping experience may include one or more of the following processes. The customer may cause customer device 300 to execute customer application 310. With reference to FIG. 2B, the screen of customer device 300 may show a GUI 650. GUI 650 may include a space 656 for display of an advertisement or other messaging. GUI 650 may include a preferences panel accessible by interacting with preferences button 654, for example by tapping and/or dragging the button. The preferences panel (not shown) may allow the user to input various details such as username, password, email, payment information, age, height, product preferences (e.g., other clothing sizes), and other information. GUI 650 may include an initiate call button 652 which may trigger an initiate call function. The initiate call function may cause the customer device to show GUI 600 and add an entry related to the customer to the customer queue 502. While waiting in the queue, the user may be shown an estimated amount of time until a sales associate will join the call. While waiting in the queue, the customer may browse the product catalogue or simply wait. Such interactions with the product catalog will be recorded to server 200 to one or both of the customer data set 520 and product data set 510.

The sales associate may cause sales associate device 400 to execute sales associate application 410. With reference to FIG. 2B, the screen of sales associate device 400 may show GUI 650. The preferences panel (not shown) may allow the user to input various details such as username, password, email, work hours, availability, and other information specific to the environment the sales associate is working in (e.g., green screen, physical store, virtual store, etc.). With reference to FIG. 2E, the GUI may include a list of customers in the customer queue 502, and optionally other information about the customers in the queue, such as how long each customer has been waiting in the customer queue. The user may tap on any of the customers to enter into a call with the customer. Alternatively, the user may tap on button 658 to be added to the sales associate queue, and the associate will automatically enter a call when the user's queue position is matched with a customer queue position after a customer joins the queue.

Once on a call, the sales associate may ask the customer questions about their needs, desires, tastes, budget, and other information necessary or desirable to promote certain items to the customer. The sales associate may also be provided with information by the system based upon verbal and non-verbal cues from the AV interaction with other information in the system to inform which product items they should suggest to the customer, and to inform which sales tactics they should employ to increase the likelihood and profit of a sale, and to improve the customer's experience. Any of this information can captured and stored on server 200, for example by asking the customer and/or sales associate questions after the end of the call.

The sales associate may use the camera of the sales associate device to scan QR codes to retrieve the catalog entry associated with that QR code. For example, if a physical store has products on the wall, one or more of the products may have QR codes beside them. During a call, the sales associate can show a product to a customer. The sales associate can scan the QR code to bring product information, video or VR/AR images of that product up on their screen so they do not need to access the product catalogue on their device, thereby saving time and possibly improving the shopping experience. It is to be understood that QR codes are used as an example, and alternatively any form of bar code or a substitute therefor could be used.

In addition to generating sales, these tactics may generate good will for the merchant and their brand. For the customer, this shopping experience may allow them to gain useful insights from the sales associate to complement the customer's appreciation of the goods that may otherwise be based only on sales catalogues, advertisements, and brochures.

### Virtual Reality

One or more of the AV streams may be used to create a virtual representation of a physical space. In addition or alternatively, such virtual representations may be created prior to a call. Virtual representations may also be created using sensors, such as a camera, LIDAR sensors, and the like. A user (customer, sales associate, or both) may navigate the virtual representation. For example, the user may navigate the virtual representation using arrows on the screen of their mobile device, using their web browser, or using a virtual reality apparatus such as a headset. Such navigation may be supported by sensors, such as any one or more of an accelerometer, a gyroscope, a camera, lidar, or other spatial technology, which may be of the customer and/or sales associate device. The virtual representation may implement virtual reality and/or augmented reality technology, such as human occlusion technology which may be used to hide or modify a background 630 behind the sales associate or customer. This may include one or more virtual representations 636 of products. The virtual representation may be modified using data about the customer, for example to curate collections that are likely to appeal to the customer, or promote products for any number of other reasons. The virtual representation may also be modified to appeal to the user by modifying the layout, colours, and other visual and spatial aspects of the virtual store.

The products promoted to a user may be selected based on machine learning and artificial intelligence. Machine learning and artificial intelligence may be implemented using data about the customer, for example, data collected using an AV stream of the customer, such as age, height, gender expression, clothing worn, time of day, etc.

The sales associate may be in a studio, on a set, in a physical store, or in any number of other locations. Any of these locations may be captured in the AV stream. The set may include televisions, projectors, or other image projection apparatus.

### Further Embodiments

With reference to FIG. 2H, multiple customers and/or sales associates may join the call, for example, using different devices. In one embodiment, the customer and/or sales associate may invite a second customer to join a call by using a group call function via a group call button 634 in the GUI 600. Any one or more of the users on the call may, via the GUI, toggle between the users to select the user visible on their screen, or may display multiple users on their screen at once.

The method may also be used for customer service, such as for demonstrations on how to use products, or to facilitate returns.

### Technical Processes

With reference to FIG. 3, a machine-implemented method 100 for facilitating a shopping experience for a customer with a customer device and a sales associate with a sales associate device is provided. The method may include handling 102 a call request, including receiving, by a processor of a server, the call request from the customer via the customer device, and adding, by the processor, a customer identifier associated with the customer to a customer queue of the database, and generating, by the processor, a set of products. The method 100 may further include causing 104 the set of products to be displayed on the customer device. The method may further include coupling 106 the customer device and the sales associate device, including displaying, on the sales associate device, the customer queue retrieved by the processor from a database of the server. The method may further include receiving 108, by the processor, a join call request from the sales associate device. The method may include initiating 110 an AV call, including causing the sales associate device to record and send a first AV stream to the customer device for display thereon. The method may include populating 112 a cart with at least one product.

The method may include concluding 114 a transaction, including receiving, from the sales associate device, a check out instruction, and triggering an order fulfillment process. The order fulfillment process may include processing payment information and arranging for the relevant products to be shipped to the customer.

The method may include ending 116 the AV call, including receiving, from one of the sales associate device and the customer device, an end call request; and collecting a first set of customer data from the customer via the customer device and collecting a second set of customer data about the customer via the sales associate device and storing the first set of customer data and the second set of customer data to the server.

### CLAUSES

Clause 1. A machine-implemented method for facilitating a shopping experience for a customer with a customer device and a sales associate with a sales associate device, comprising: handling a call request, including receiving, by a processor of a server, the call request from the customer via the customer device, and adding, by the processor, a customer identifier associated with the customer to a customer queue of the database, generating, by the processor, a set of products; causing the set of products to be displayed on the customer device; coupling the customer device and the sales associate device, including displaying, on the sales associate device, the customer queue retrieved by the processor from a database of the server; receiving, by the processor, a join call request from the sales associate device; and initiating an AV call, including causing the sales associate device to record and send a first AV stream to the customer device for display thereon; populating a cart with at least one product; concluding a transaction, including receiving, from the sales associate device, a check out instruction, and triggering an order fulfillment process; and ending the AV call, including receiving, from one of the sales associate device and the customer device, an end call request; and collecting a first set of customer data from the customer via the customer device and collecting a second set of customer data about the customer via the sales associate device and storing the first set of customer data and the second set of customer data to the server.

Clause 2. The method of any one or more of clauses 1-24, further comprising: collecting a third set of customer data directly from the customer, and storing the third set of customer data on the database.

Clause 3. The method of any one or more of clauses 1-24, further comprising: retrieving a fourth set of customer data about the customer from a tracking service using the third set of customer data, and storing the fourth set of customer data on the database.

Clause 4. The method of any one or more of clauses 1-24, further comprising: pushing, by the processor, a customer waiting notification to the sales associate device.

Clause 5. The method of any one or more of clauses 1-24, further comprising: matching the customer at a beginning of the customer queue with the sales associate.

Clause 6. The method of any one or more of clauses 1-24, wherein causing the set of products to be displayed on the customer device further comprises: selecting products of the set based on data about the customer in the database.

Clause 7. The method of any one or more of clauses 1-24, wherein populating the cart further comprises: adding the set of products to the cart.

Clause 8. The method of any one or more of clauses 1-24, further comprising: causing the customer device to record and send a second AV stream to the sales associate device.

Clause 9. The method of any one or more of clauses 1-24, wherein populating the cart further comprises: receiving, via the customer device, a product selected by the customer to be added to the cart.

Clause 10. The method of any one or more of clauses 1-24, wherein populating the cart further comprises: receiving, from the sales associate device, a product to be added to the cart.

Clause 11. The method of any one or more of clauses 1-24, further comprising: displaying, on the sales associate device, a set of suggested products for promotion to the customer.

Clause 12. The method of any one or more of clauses 1-24, wherein the set of suggested products is selected based on data in the database about the customer.

Clause 13. The method of any one or more of clauses 1-24, wherein the set of suggested products is selected based on data in the database about how the customer has interacted with previous products.

Clause 14. The method of any one or more of clauses 1-24, wherein the set of suggested products is selected based on data in the database about product inventory.

Clause 15. The method of any one or more of clauses 1-24, further comprising: monitoring the customer's interaction with the set of products and storing customer interaction data to the database.

Clause 16. The method of any one or more of clauses 1-24, wherein interaction includes a flag placed by the customer device on one or more of the products of the set of products.

Clause 17. The method of any one or more of clauses 1-24, further comprising: customizing a graphical user interface of the customer device based on data about the customer in the database.

Clause 18. The method of any one or more of clauses 1-24, wherein: the first AV stream is enhanced using chroma key compositing.

Clause 19. The method of any one or more of clauses 1-24, wherein: the first AV stream is enhanced using augmented reality human occlusion to modify a background of the first AV stream.

Clause 20. The method of any one or more of clauses 1-24, further comprising: receiving, from a merchant device, a third AV stream; and sending the third AV stream to the customer device for display thereon.

Clause 21. The method of any one or more of clauses 1-24, further comprising: establishing a virtual representation of a physical location, including using at least one AV stream.

Clause 22. The method of any one or more of clauses 1-24, further comprising: navigating the virtual representation using a sensor of the customer device.

Clause 23. The method of any one or more of clauses 1-24, further comprising: navigating the virtual representation using a virtual reality device.

Clause 24. The method of any one or more of clauses 1-24, further comprising: navigating the virtual representation using a graphical user interface of the customer device.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A machine-implemented method for facilitating a shopping experience for a customer with a customer device and a sales associate with a sales associate device, comprising:
handling a call request, including
receiving, by a processor of a server, the call request from the customer via the customer device, and
adding, by the processor, a customer identifier associated with the customer to a customer queue of the database,
generating, by the processor, a set of products;
causing the set of products to be displayed on the customer device;
coupling the customer device and the sales associate device, including
displaying, on the sales associate device, the customer queue retrieved by the processor from a database of the server;
receiving, by the processor, a join call request from the sales associate device; and
initiating an AV call, including
causing the sales associate device to record and send a first AV stream to the customer device for display thereon;
populating a cart with at least one product;
concluding a transaction, including
receiving, from the sales associate device, a check out instruction, and triggering an order fulfillment process; and
ending the AV call, including
receiving, from one of the sales associate device and the customer device, an end call request; and
collecting a first set of customer data from the customer via the customer device and collecting a second set of customer data about the customer via the sales associate device and storing the first set of customer data and the second set of customer data to the server.

2. The method of claim 1, further comprising:
collecting a third set of customer data directly from the customer, and
storing the third set of customer data on the database.

3. The method of claim 2, further comprising:
retrieving a fourth set of customer data about the customer from a tracking service using the third set of customer data, and
storing the fourth set of customer data on the database.

4. The method of claim 1, further comprising:
pushing, by the processor, a customer waiting notification to the sales associate device.

5. The method of claim 1, further comprising:
matching the customer at a beginning of the customer queue with the sales associate.

6. The method of claim 1, wherein causing the set of products to be displayed on the customer device further comprises:
selecting products of the set based on data about the customer in the database.

7. The method of claim 6, wherein populating the cart further comprises:
adding the set of products to the cart.

8. The method of claim 1, further comprising:
causing the customer device to record and send a second AV stream to the sales associate device.

9. The method of claim 1, wherein populating the cart further comprises:
receiving, via the customer device, a product selected by the customer to be added to the cart.

10. The method of claim 1, wherein populating the cart further comprises:
receiving, from the sales associate device, a product to be added to the cart.

11. The method of claim 1, further comprising:
displaying, on the sales associate device, a set of suggested products for promotion to the customer.

12. The method of claim 11, wherein the set of suggested products is selected based on data in the database about the customer.

13. The method of claim 11, wherein the set of suggested products is selected based on data in the database about how the customer has interacted with previous products.

14. The method of claim 11, wherein the set of suggested products is selected based on data in the database about product inventory.

15. The method of claim 1, further comprising:
monitoring the customer's interaction with the set of products and storing customer interaction data to the database.

16. The method of claim 11, wherein interaction includes a flag placed by the customer device on one or more of the products of the set of products.

17. The method of claim 1, further comprising:
customizing a graphical user interface of the customer device based on data about the customer in the database.

18. The method of claim 1, wherein:
the first AV stream is enhanced using chroma key compositing.

19. The method of claim 1, wherein:
the first AV stream is enhanced using augmented reality human occlusion to modify a background of the first AV stream.

20. The method of claim 1, further comprising:
receiving, from a merchant device, a third AV stream; and
sending the third AV stream to the customer device for display thereon.

21. The method of claim 1, further comprising:
establishing a virtual representation of a physical location, including using at least one AV stream.

22. The method of claim 21, further comprising:
navigating the virtual representation using a sensor of the customer device.

23. The method of claim 21, further comprising:
navigating the virtual representation using a virtual reality device.

24. The method of claim 21, further comprising:
navigating the virtual representation using a graphical user interface of the customer device.
